(19) United States
(12) Patent Application Publication
(10) Pub. No.: US 2014/0241841 A1
(43) Pub. Date: Aug. 28, 2014

(54) Construction Machine

(71) Applicant: Liebherr-Hydraulikbagger GmbH, Kirchdorf/Iller (DE)

(72) Inventors: Daniel VELOSO, Memmingen (DE); Stefan SCHOTT, Memmingen (DE); Michael REUTHLINGER, Erlenmoos (DE); Dirk ASAM, Ulm (DE)

(73) Assignee: Liebherr-Hydraulikbagger GmbH, Kirchdorf/Iller (DE)

(21) Appl. No.: 14/191,895

(22) Filed: Feb. 27, 2014

(30) Foreign Application Priority Data
Feb. 28, 2013 (DE) 10 2013 003 491.4

(51) Int. Cl. B66C 23/64; E02F 3/36; E02F 3/38

(52) U.S. Cl. CPC B66C 23/64; E02F 3/382; E02F 3/3695
USPC 414/722; 285/61; 212/347

(57) ABSTRACT

A construction machine, such as an excavator, a loader, or a crane, has at least one hydraulic attachment, such as an arm of the excavator, the loader, or the crane. The attachment includes at least one pivot bearing, a separator plate provided at the pivot bearing, at least one first hydraulic line, and at least one second hydraulic line, with the separator plate connectable to the pivot bearing and the hydraulic lines.

### CROSS REFERENCE TO RELATED APPLICATION

This application claims priority under 35 U.S.C. §119 to German Patent Application No. 10 2013 003 491.4, filed Feb. 28, 2013, the entire disclosure of which is expressly incorporated herein by reference.

### BACKGROUND OF THE INVENTION

The present invention relates to a construction machine having an attachment which has at least one pivot bearing and hydraulic lines, with hydraulic lines extending through the pivot bearing.

Construction machinery such as excavators, loaders or cranes have attachments which are configured as excavator arms, loader arms or crane arms according to their area of application. In this respect, they have different part sections which are arranged movable relative to one another.

An excavator arm comprises an attachment item such as a bucket and one or more part sections which are supported rotatable relative to one another via joints or pivot bearings. The movement of the individual part sections of the attachments in this respect typically takes place by means of hydraulic cylinders which are accordingly connected to the part sections of the attachment. However, apparatus are equally conceivable in which drives other than hydraulic are utilized for moving the attachment or its part sections.

Embodiments are conceivable in operation of the attachment with one or more hydraulic cylinders and correspondingly different numbers of hydraulic lines. For reasons of simplicity, one hydraulic cylinder and one hydraulic line can be spoken of in the following; however, this always includes an embodiment having more than one hydraulic cylinder and a corresponding plurality of hydraulic lines. Equally, one pivot bearing can be spoken of in the following; however, this likewise always includes an embodiment having more than one pivot bearing.

A supply with a pressure medium is required for operating the hydraulic cylinder and typically takes place via hydraulic lines which connect the hydraulic cylinder to a hydraulic oil source. This hydraulic oil source is typically not located at the attachment itself, but is rather arranged in the region of the construction machine which has the attachment.

It is thus necessary to provide a hydraulic connection between the hydraulic oil source at the construction machine, on the one hand, and the hydraulic cylinder at the attachment, on the other hand, with the hydraulic connection optionally leading up to an end region of the attachment in which, in the case of an excavator, an attachment item such as an excavator bucket is located which is supported movable by a hydraulic cylinder. Since the hydraulic line thus extends between parts sections of the attachment which are rotatable relative to one another, the hydraulic line, which also extends in the region of the pivot bearing of the attachment without any separation, undergoes particular bending strain and torsional strain due to the rotary movements of the attachment. To minimize the length changes due to the rotary movements in this respect, a laying of the hydraulic lines in the region of the center of rotation or of the instant center is aimed for, with the hydraulic lines in this respect being able to be held together using suitable apparatus for the purpose of a provision which is as compact as possible.

Hose damage can be caused or accelerated by these strains and relative movements of the hydraulic lines at the instant centers, which can result in a defect of the hydraulic system. It is particularly problematic in this respect that the undefined bending strains and torsional strains represent an uncontrolled superposition of different strains which can have a particularly disadvantageous effect on the service life of the hydraulic lines.

### SUMMARY OF THE INVENTION

It is therefore one object of the present invention to advantageously further develop a construction machine in accordance with the invention such that the failure probability of the hydraulic lines is lowered.

This object is achieved in accordance with the invention by an apparatus according to which a construction machine, such as an excavator, a loader, or a crane, is provided with at least one hydraulic attachment such as an arm of an excavator, of a loader or of a crane, wherein the attachment comprises at least one pivot bearing, having at least one separator plate provided at the pivot bearing, having at least one first hydraulic line, and having at least one second hydraulic line, wherein the at least one separator plate is or can be connected to the at least one pivot bearing and to the hydraulic lines.

By the introduction of a separation point in the form of the separator plate, which represents a connection possibility or screw connection possibility of hydraulic components which is or can be attached anywhere in space, every hydraulic component advantageously undergoes exactly one type of strain due to a rotary movement of the attachment. A superposition of different strains or of a plurality of strains is precluded by the separation point since hydraulic components which are located at a first side of the separator plate are only influenced by movements of the attachment which likewise take place at the first side of the separator plate. Conversely, movements of the attachment which take place at a second side of the separator plate do not influence the hydraulic components which are located at the first side of the separator plates, but only those which are located at the second side of the separator plate. Each hydraulic component only undergoes one defined strain and further fastening points or holders of the hydraulic components can be dispensed with. It is made possible by the arrangement of the hydraulic components predefined by the separation point that the bending radii of the hydraulic hoses are increased and thus their failure probability is decreased.

A further advantage is that the first assembly on the manufacture of a construction machine in accordance with the invention is facilitated and accelerated by the clear, defined and simple separator plates. A similar advantage can be found in the fact that the clearly defined separation points and the construction of the pivot bearing in accordance with the invention which is simplified thereby results in a time saving in the replacement of hydraulic lines, whereby the failure times of the unit in the event of a repair are reduced.

Provision is made in a preferred embodiment that the at least one separator plate comprises at least one connection section at which the at least two hydraulic lines are or can be connected to one another and/or to the at least one separator plate.

In the simplest case, one of the hydraulic lines can in this respect be led through an aperture in the separator plate, with the aperture itself representing the connection section of the separator plate. A second hydraulic line can be connected to the first hydraulic line and can be fixedly connected thereto. In this manner, the thread geometries typically already present at hydraulic lines can be used for fastening the hydraulic lines to the separator plate so that no additional apparatus has to be provided for this purpose.

It is conceivable in a further preferred embodiment that the at least two hydraulic lines are or can be connected to one another and/or to the at least one separator plate and/or to the at least one pivot bearing in a shape-matched manner and/or in a force transmitting manner and/or with material continuity.

Such a connection of the different elements of the attachment advantageously allows the loss-free transfer of pressurized hydraulic fluid between the two hydraulic lines, on the one hand, and a stabilization of the hydraulic lines takes place with respect to forces which act on the hydraulic lines due to the movement of the attachment, on the other hand. In contrast to a continuous hydraulic line which is not separated by a separator plate and so is not stabilized by means of the separator plate by connection to the pivot bearing, bending forces and torsion forces are not transmitted from one hydraulic line into the other or from a first section of a hydraulic line into a second section of a hydraulic line in the present invention. The corresponding bending forces and torsion forces are rather introduced into the pivot bearing by means of the separator plate. An influencing of the hydraulic lines is thus avoided, transfers of movements from one hydraulic line to the other or from a first section of a hydraulic line into a second section of a hydraulic line, which can result in increased wear phenomena, do not occur.

It is conceivable in a further preferred embodiment that the at least two hydraulic lines are or can be fixed relative to one another in the region of the at least one separator plate and/or relative to the at least one pivot bearing by means of the at least one separator plate.

Such a fixing in accordance with the invention of the hydraulic lines relative to one another or relative to the further elements of the attachment advantageously allows the hydraulic lines to be acted on by bending forces and torsion forces independently of one another during the movement of the attachment. Forces which are introduced into a hydraulic line from a side of the pivot bearing are taken up by the separator plate and are introduced into the pivot bearing. The forces are not transmitted into the second hydraulic line so that no disadvantageous superposition of forces promoting the wear of the hydraulic lines occurs there.

In a further preferred embodiment, a construction machine is conceivable in which the at least two hydraulic lines are or can be connected to the at least one separator plate and/or to one another via at least one screw connection section and that the at least two hydraulic lines are or can be fixed relative to one another and/or relative to the at least one separator plate and/or relative to the at least one pivot bearing by means of the at least one screw connection section.

In this embodiment, the screw connection sections typically provided at hydraulic lines are advantageously used to allow the connection between the hydraulic lines, the separator plate and the pivot bearing. Standard parts can thus be made use of and no separate apparatus are required to realize the connection in accordance with the invention.

It is conceivable in a further preferred embodiment that the at least one separator plate comprises at least one positioning plate which is made in one piece, which has at least the one connection section and which is or can be connected directly to at least half the hydraulic lines.

This single-part embodiment is particularly advantageous when more than two hydraulic lines are to be guided through the pivot bearing via the separator plate. It namely allows it to be fixed in advance on the construction side which geometry the hydraulic lines should adopt with respect to one another and to the pivot bearing. Since the separator plate or its positioning plate is present in one piece, it clearly defines by its geometry during the assembly how the hydraulic lines are to be assembled in agreement with the construction parameters. Once namely the at least one connection section has been predefined on the separator plate or on its positioning plate made in one piece due to the construction, a defective connection of the hydraulic lines, i.e. a connection not provided in this manner by the construction, can no longer easily take place during the assembly process.

It is conceivable in a further preferred embodiment that the at least one separator plate is provided from a material having torsional stiffness such as a metal, a metal alloy, a fiber composite or a plastic having comparable properties.

The corresponding material selection in this respect advantageously makes it possible to minimize the relative movements between the hydraulic lines themselves, on the one hand, and between the hydraulic lines and the pivot bearing, on the other hand. Since as a rule attachments in the sense of the invention are made from steels, the use of a steel separator plate from just this material immediately suggests itself. Any other material which allows an arrangement fixing the hydraulic lines is nevertheless also made possible in accordance with the invention.

It is conceivable in a further preferred embodiment that the at least one separator plate is provided in the region of the instant center of the at least one pivot bearing.

It is advantageously ensured in this manner that the movement of the hydraulic lines which are the cause of the forces which are introduced into to the pivot bearing by the hydraulic lines is kept as small as possible.

It is conceivable in a further preferred embodiment that the hydraulic liens are arranged in the interior region of the attachment.

This hose laying through the pivot bearing advantageously makes it possible, on the one hand, to provide the driver with a better overview of the unit since his view is not restricted by hydraulic lines which extend along the attachment and thus affect the most relevant work area for the driver. On the other hand, due to the inwardly disposed laying of the hydraulic lines, the possibility of damage to the hydraulic lines by external influences such as can be caused by contact with construction site structures in construction site operation is precluded.

The present invention will now be explained in more detail with reference to an embodiment and to the drawings.

### BRIEF DESCRIPTION OF THE DRAWINGS

FIG. 1 shows a superstructure of a construction machine in accordance with the invention;

FIG. 2 shows a pivot bearing of a construction machine in accordance with the invention; and

FIG. 3 shows a separator plate with hydraulic lines.

### DETAILED DESCRIPTION OF THE INVENTION

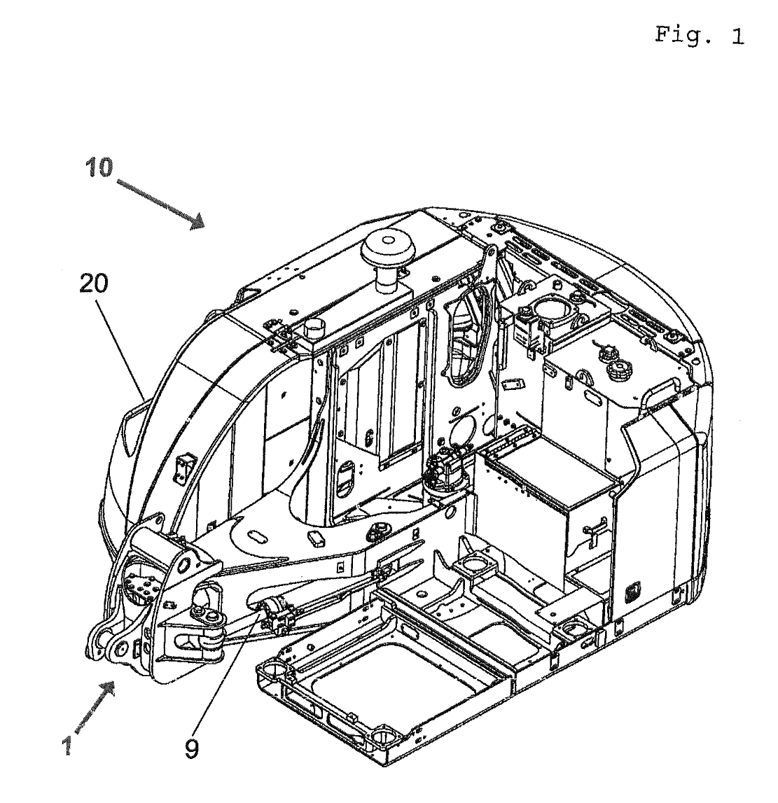

The structure shown in FIG. 1 represents the superstructure 10 of a construction machine in accordance with the invention. The construction machine can, for example, be a mobile excavator or a transfer unit designed as a mobile excavator which comprises an undercarriage, not shown, supporting a traveling gear, and the superstructure 10 pivotally connected thereto.

In construction machines of this category, the undercarriage in this respect carries traveling gear which can be designed, for example, as simple wheeled traveling gear or as crawler traveling gear. The type of traveling gear used is in this respect not relevant to the invention.

The superstructure 10 substantially comprises a revolving deck on whose upper side and on whose side wall disposed at the right in the direction of travel all modules of the superstructure 10 are arranged at standardized interfaces. In the front region of the superstructure 10, a pivot bearing 1 is provided in the present case which serves for receiving a piece of equipment or an attachment, not shown. A hydraulic cylinder 9 which is designed for pivoting the pivot bearing 1 is connected to the pivot bearing 1.

The superstructure 10 further comprises the operator's workplace 20 which substantially comprises an operator's cabin and a control unit, not shown, in a construction unit. In an embodiment in which the construction machine is designed as a transfer unit, this operator's workplace 20 can optionally be supplemented with rigid elevated portions, hydraulic elevated portions and/or tilt apparatus. Furthermore, hydraulic tanks, fuel tanks and/or a climbing box are conceivable at the superstructure 10. They can be arranged at the upper side or at the side wall of the revolving deck disposed at the right in the direction of travel.

Embodiments having different tank volumes are conceivable with respect to the fuel tank. A drive module can likewise be provided at the upper side or at the side wall of the revolving deck disposed at the right in the direction of travel. The drive module can be an internal combustion engine or also an electric motor having a fuel cell or batteries.

A ballast weight can furthermore likewise be attached to the upper side of the revolving deck. Provision can be made by a standardization of the superstructure width and of the superstructure height that the ballast weights can be replaced across unit types, whereby the payload behavior of the machine can be varied in a very simple manner.

A control slider console which includes the entire valve arrangement is likewise provided at the upper side or at the side wall of the revolving deck 10 disposed at the right in the direction of travel.

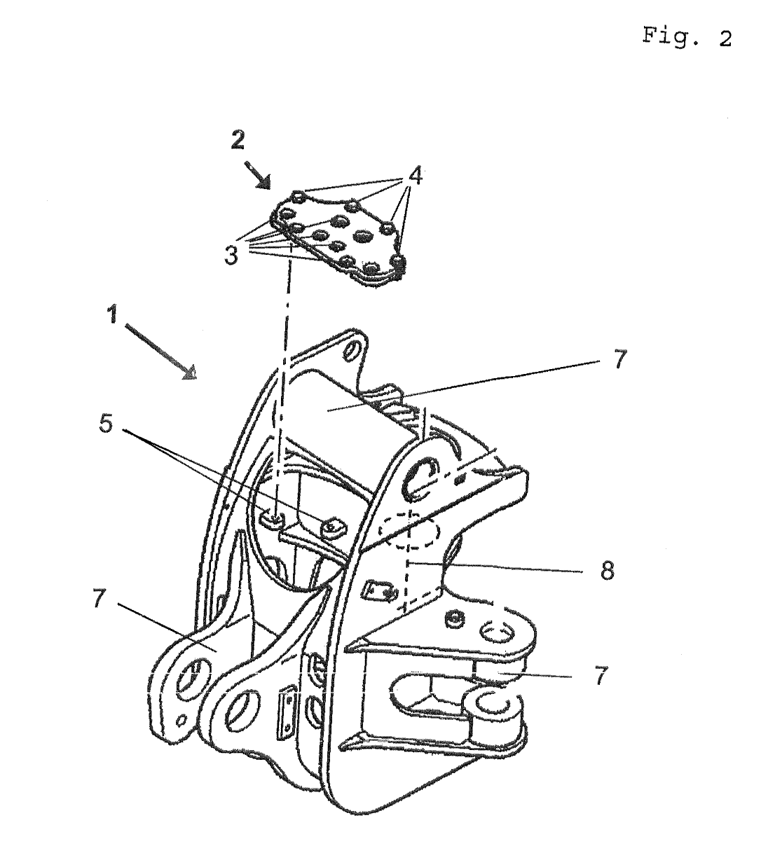

FIG. 2 is an exploded view of the pivot bearing 1 with a separator plate 2 separate therefrom. The separator plate 2 has a plurality of connection sections 3 which are designed as simple apertures 3 in the embodiment shown. As can be seen from the drawing, the separator plate 2 can be mounted within the structure of the pivot bearing 1. For this purpose, it is connected to the pivot bearing 1 via four connection screws 4. The pivot bearing 1 has corresponding consoles 5 on which the separator plate 2 can be supported and into which the connection screws 4 can be introduced.

Furthermore, different connection geometries 7 are provided at the pivot bearing 1 via which the pivot bearing 1 can be connected to the superstructure 10, to the attachment and to the hydraulic cylinder 9. The hydraulic cylinder 9 in this respect pivots the pivot bearing 1 about a vertical axis 8, whereby the entire attachment can be pivoted about this axis 8.

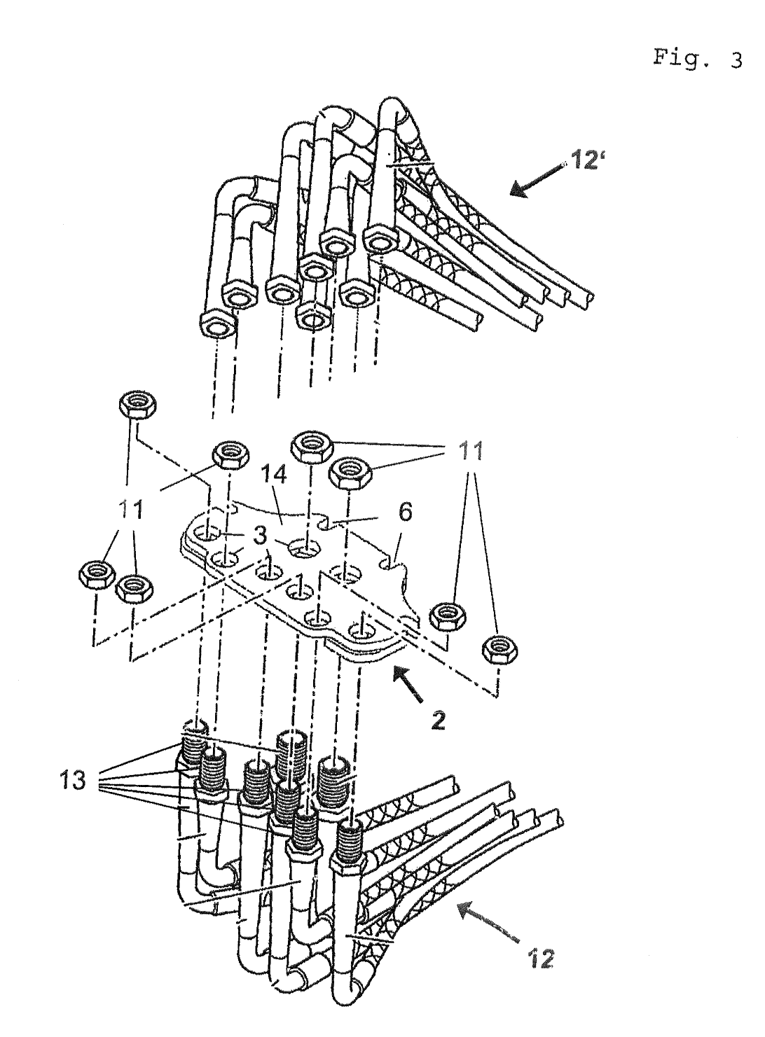

FIG. 3 shows the separator plate 2 with cut-outs 6 and apertures 3 as well as with a plurality of fixing screws 11 and a plurality of first hydraulic lines 12 as well as a plurality of second hydraulic lines 12′ in an exploded view. The first hydraulic lines 12 have screw connection sections 13. The connection screws 4 can be led through the separate plate 2 through the cut-outs 6 in order thus to allow a connection of the separator plate 2 to the consoles 5 and thus to the pivot bearing 1.

The first hydraulic lines 12, which are located on the first side of the separator plate 2, can be led through the apertures 3 and can thus be fixed to the separator plate 2 by means of the fixing nuts 11. Further, second hydraulic lines 12′, which are located on the second side of the separator plate 2, can be connected to the screw connection sections 13 of the first hydraulic lines 12.

The separator plate 2 in the embodiment shown comprises a positioning plate 14 which is designed in one piece. As can be seen from the drawing, it is thereby possible to fix the individual hydraulic lines 12, 12′ particularly easily relative to one another and relative to the separator plate 2 and thus also relative to the pivot bearing 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A construction machine, such as an excavator, a loader, or a crane, having at least one hydraulic attachment, the attachment comprising:
at least one pivot bearing,
at least one separator plate provided at the pivot bearing,
at least one first hydraulic line, and
at least one second hydraulic line,
wherein the at least one separator plate is connectable to the at least one pivot bearing and to the hydraulic lines.

2. A construction machine in accordance with claim 1, wherein the at least one separator plate comprises at least one connection section to which the at least one first hydraulic line and the at least one second hydraulic line are connectable to one another and/or to the at least one separator plate.

3. A construction machine in accordance with claim 1, wherein the at least one first hydraulic line and the at least one second hydraulic line are connectable to one another and/or to the at least one separator plate and/or to the at least one pivot bearing in a shape-matched manner, in a force transmitting manner, and/or with material continuity.

4. A construction machine in accordance with claim 1, wherein the at least one first hydraulic line and the at least one second hydraulic line are fixable relative to one another and/or relative to the at least one pivot bearing in a region of the at least one separator plate by way of the at least one separator plate.

5. A construction machine in accordance with claim 1, wherein the at least one first hydraulic line and the at least one second hydraulic line are connectable to the at least one separator plate via at least one screw connection section, and wherein the at least one first hydraulic line and the at least one second hydraulic line are fixable relative to one another and/or relative to the at least one separator plate and/or relative to the at least one pivot bearing by way of the at least one screw connection section.

6. A construction machine in accordance with claim 2, wherein the at least one separator plate comprises at least one positioning plate, which is made in one piece, and which has the at least one connection section and is connectable directly to at least half of the hydraulic lines.

7. A construction machine in accordance with claim 1, wherein the at least one separator plate is made from a metal material, a metal alloy material, a fiber composite material, a plastic material, or another material having torsional stiffness.

8. A construction machine in accordance with claim 1, wherein the at least one separator plate is provided in a region of an instant center of the at least one pivot bearing.

9. A construction machine in accordance with claim 1, wherein the hydraulic lines are arranged in an interior region of the attachment.

10. A construction machine in accordance with claim 1, wherein the at least one hydraulic attachment is an arm of an excavator, an arm of a loader, or an arm of a crane.

11. A hydraulic attachment for a construction machine, the attachment comprising:
at least one pivot bearing,
at least one separator plate provided at the pivot bearing,
at least one first hydraulic line, and
at least one second hydraulic line,
wherein the at least one separator plate is connectable to the at least one pivot bearing and to the hydraulic lines.

12. A hydraulic attachment in accordance with claim 11, wherein the at least one separator plate comprises at least one connection section to which the at least one first hydraulic line and the at least one second hydraulic line are connectable to one another and/or to the at least one separator plate.

13. A hydraulic attachment in accordance with claim 11, wherein the at least one first hydraulic line and the at least one second hydraulic line are connectable to one another and/or to the at least one separator plate and/or to the at least one pivot bearing in a shape-matched manner, in a force transmitting manner, and/or with material continuity.

14. A hydraulic attachment in accordance with claim 11, wherein the at least one first hydraulic line and the at least one second hydraulic line are fixable relative to one another and/or relative to the at least one pivot bearing in a region of the at least one separator plate by way of the at least one separator plate.

15. A hydraulic attachment in accordance with claim 11, wherein the at least one first hydraulic line and the at least one second hydraulic line are connectable to the at least one separator plate via at least one screw connection section, and wherein the at least one first hydraulic line and the at least one second hydraulic line are fixable relative to one another and/or relative to the at least one separator plate and/or relative to the at least one pivot bearing by way of the at least one screw connection section.

16. A hydraulic attachment in accordance with claim 12, wherein the at least one separator plate comprises at least one positioning plate, which is made in one piece, and which has the at least one connection section and is connectable directly to at least half of the hydraulic lines.

17. A hydraulic attachment in accordance with claim 11, wherein the at least one separator plate is made from a metal material, a metal alloy material, a fiber composite material, a plastic material, or another material having torsional stiffness.

18. A hydraulic attachment in accordance with claim 11, wherein the at least one separator plate is provided in a region of an instant center of the at least one pivot bearing.

19. A hydraulic attachment in accordance with claim 11, wherein the hydraulic lines are arranged in an interior region of the attachment.

20. A hydraulic attachment in accordance with claim 11, wherein the construction machine is an excavator, a loader, or a crane, and the hydraulic attachment is an arm.
